(19) United States
(12) Patent Application Publication
(10) Pub. No.: US 2009/0012767 A1
(43) Pub. Date: Jan. 8, 2009

(54) Method for Selecting Potential Medicinal Compounds

(76) Inventors: Dmitry Gennadievich Tovbin, Malakhovka (RU); Dmitry Nikolaevich Tarasoy, Dubna (RU)

Correspondence Address: LADAS & PARRY LLP, 26 WEST 61ST STREET, NEW YORK, NY, 10023, US

(21) Appl. No.: 12/159,632

(22) PCT Filed: Jan. 20, 2006
(86) PCT No.: PCT/RU2006/000015

§ 371 Date: Jun. 30, 2008

(51) Int. Cl. G06G 7/58

(52) U.S. Cl. 703/11

(57) ABSTRACT

A method for the structure based drug design, searching for and selection of potential medicinal compounds is proposed, which comprises predicting the value of the ligand binding affinities from the score calculated with the help of a scoring function with taking into account the protein structure, the ligand structure and the ligand position in the protein binding site. In the elaboration of the scoring function information about the already known both active and inactive ligands is employed. The use of the information about the inactive ligands makes the proposed method of elaborating the scoring function fundamentally different from all the known methods and allows not only to essentially improve the quality of the scoring function being elaborated, but also to constantly improve this quality as new experimental data become available.

### FIELD OF THE ART

The present invention relates to medical chemistry and may be used for searching for medicinal substances having a required biological activity or function.

### STATE OF THE ART

There exists a whole group of drugs which are relatively small chemical compounds capable of binding to definite proteins in an organism in a definite region on a protein, which is called binding site. It is known that the quality of this interaction is determined by the binding affinity or the binding free energy of the chemical compound-protein interaction. The smaller the binding free energy, the stronger the interaction is. All chemical substances which may be candidates for the role of drugs and interact with a protein are called ligands. A ligand which interacts with a protein in a binding site with an energy smaller than −9 kcal/mole is referred to as active for a given protein.

One of the main goals of structural drug design is to predict and find active ligands for a prescribed protein, using the structure of the binding site of this protein. To solve this problem, reliable and fast numerical methods for predicting the ligand-protein interaction are required.

In the course of searching for new active ligands the following technologies have received wide recognition: de novo drug design, virtual screening, and docking.

De novo drug design comprises creating a virtual ligand having a minimum score, with indicating its position in the binding site.

Virtual screening comprises docking a multiplicity of ligands into the protein binding site and ranging these ligands in accordance with the score obtained as a result of docking, with a view to selecting the ligands with the best score.

Provided that the de novo drug design and virtual screening operate correctly, the selected ligands must be the most active for a given protein.

Docking of a ligand comprises a process of selecting such position of a ligand in the binding site of a protein, in which the ligand has the best score. Score is the number which is determined by the structure of the ligand, by the structure of the binding site, and depends on the position of the ligand in the binding site. Score is also understood as a set of methods which make it possible to calculate the score value. Correct score must be proportional to the binding affinity or the binding free energy of the ligand-protein interaction (Gohlike, H.; Hendlich, M.; Klebe, G. Angew. Int. Ed. 2004, 41, 2644-2676).

The scores or approaches to predicting the ligand-protein interaction from the structure and position of the protein and the ligand may be divided into several groups: molecular dynamics, physical methods based on force fields, empirical and knowledge based (Gohlke, H.; Handlich, M.; Klebe, G. Angew. Chem. Int. Ed. 2004, 41, 2144-2676).

The most widespread approaches to predicting the ligand-protein interaction from the structure of the protein and of the ligand and from the position of the ligand in the protein binding site are empirical. These methods are the fastest and simplest. The interaction prediction speed is one of decisive factors in the structural drug design, because fast methods allow carrying out complete enumeration of multiplicities of molecules and positions of molecules with a view to finding an optimal molecule and its position.

The empirical methods for predicting the ligand-protein interaction from the structure of the protein, the structure of the ligand and the position of the ligand in the protein binding site are based on a set of structures of proteins, of ligands in the binding sites of these proteins and of experimentally known binding affinities for these proteins and ligands. In the empirical methods a certain physically reasonable model of the ligand-protein interaction is proposed. In this model some parameters are selected—trained—so that the binding affinity or the free energy predicted by the model for the known structures of proteins and ligands should most closely correspond to the experimentally known binding affinities or free energies for these proteins and ligands.

The basic rule in empirical approaches is: an empirical model operates correctly only if the problem to which it is applied is analogous with the problem on which the model was developed and the object to which the model is applied are analogous with the objects which were used in elaborating the model.

The task of the virtual screening and de novo drug design is to separate active ligands from inactive ones on one particular protein, whereas in developing empirical scores, currently use is made only of information only about active ligands, and for different proteins simultaneously. In the judgment of the authors of the present invention, this particular inconsistency is responsible for all the main problems in using the known empirical scores for the virtual screening and de novo drug design.

In the opinion of the authors, the quality of the scores and therefore the quality of the virtual screening and design of potentially active ligands at the current moment are not always acceptable. The quality of virtual screening carried out by the same docking program but with different scores substantially differ. One and the same score may operate adequately in the course of virtual screening on one protein but operate poorly on another protein (Bissantz, C.; Folkers, G.; Rognan, D. J. Med. Chem. 2000, 43, 4759-4767).

For improving the quality of the virtual screening and design of potentially active ligands, a multiplicity of methods have been developed: additional filters for eliminating inherently wrong positions, joint use of several scores simultaneously in a consensus scoring, etc. (Claussen H.; Gastreich, M.; Apelt, V.; Greene, J.; Hindle, S. A.; Lemmen, C. Curent Drug Discovery Technologies, 2004, 1, 49-60). All these methods attempt to find a universal solution which would operate adequately well for all types of proteins and ligands. As an alternative, there exists another approach as well: elaboration of focused scores for virtual screening and design of potentially active ligands on a specific target. At the moment there are known several procedures for creating focused scores, which have made a good showing (Claussen H.; Gastreich, M.; Apelt, V.; Greene, J.; Hindle, S. A.; Lemmen, C. Curent Drug Discovery Technologies, 2004, 1, 49-60).

Development of focused empirical scores is a promising technology also in view of the fact that the corpus of data about proteins and active ligands for given proteins grows extremely both within private pharmaceutical companies and in the academic community.

### ESSENCE OF THE INVENTION

It is an object of the present invention to provide a new method for selecting potential medicinal compounds, which comprises predicting the value of the binding affinity or the free energy of the ligand-protein interaction from the score calculated with the help of a scoring function for a molecular complex comprising a ligand molecule and a protein molecule with taking into account the protein structure, the ligand structure and the ligand position in the protein binding site, constructing of the scoring function being characterized in that the scoring function for said molecular complex is constructed with the use of active and inactive ligands. The method contemplates the following steps:

a) selecting a set of experimental data about the position of active ligands in the binding site of protein for which a score will be elaborated;
b) selecting a set of experimental data about the positions of inactive ligands in the binding site of protein for which a score will be elaborated;
c) modifying the known initial score in such a manner that for each active ligand from the set obtained in step a) the value of a new score should be smaller than its value calculated for any position of inactive ligand from the set obtained in step b); and/or
d) selecting a set of experimental data about the position of active ligands in the binding site of arbitrary proteins;
e) modifying the known initial score in such a manner that for each active ligand from the set obtained in step d) the value of a new score should be smaller than its value calculated for any position of inactive ligand from the set obtained in step b);
f) carrying out virtual screening of ligands with the new score and, if necessary, evaluating its quality;
g) selecting ligands with the minimum score value and measuring the binding free energy and, if necessary, repeating steps a)-e) until a ligand with a binding free energy less than −9 kcal/mole is detected.

A distinctive feature of the method is using as training ligands not only ligands having a considerable free energy of interaction with proteins, but also any other ligands, in particular, ligands that do not have a considerable free energy of interaction with proteins, as well as using as training data not only the positions of ligands in the protein binding site, in which ligands have a considerable free energy of interaction with proteins, but also all other positions of ligands, in which they do not have a considerable free energy of interaction with proteins.

Due to the fact that experimental structures for inactive ligands do not exist (since positions of inactive ligands in a protein binding site, in which binding occurs, do not exist, and binding does not occur at all), the authors of the invention proposed to use any positions of inactive ligands in the protein binding site as such positions of inactive ligands for training parameters in an empirical model.

The general approach proposed in the present invention is conditionally divided into two methods:

a)—method with the use of information about the position of active ligands in the binding site of protein for which a score is elaborated; in this method a certain initial score is modified so that a new score for inactive ligands should be worse than a new score in the known positions of active ligands in the given protein binding site;

b)—method with the use of information about the position of active ligands in the binding site of proteins and their experimental binding affinities, these proteins being other than the protein for which the score is elaborated; in this method a certain initial score is modified so that a new score for any positions of inactive ligands should be worse than a definite value, and the correlation between the new score for the set of the known complexes of proteins with ligands after local minimization of these ligands from the native position in the binding site and the experimental binding affinities known for these complexes should be realized in the best way.

The present invention also contemplates a combination of these two methods.

### BRIEF DESCRIPTION OF THE FIGURES

FIG. 1 shows parameters q (a) and EF—enrichment factor—(the size of the group for the investigation was 2% of the number of the ligands participating in virtual screening) (b), for virtual screenings with scores modified according to method 1 depending on n—the number of random inactive ligands in the training set for trypsin proteins, tk and cdk2.

FIG. 2 shows parameters q (a) and EF—enrichment factor—(the size of the group for the investigation was 2% of the number of the ligands participating in virtual screening) (b), for virtual screenings with scores modified according to method 2 depending on n—the number of random inactive ligands in the training set for trypsin proteins, tk and cdk2.

The invention will be further described in more detail with presenting examples of carrying out the invention. These examples are only illustrative and cannot be used for limiting the scope of the inventors' claims.

### DETAILED DESCRIPTION OF THE INVENTION

The authors of the invention have carried out a number of virtual screenings. In the course of virtual screening docking was carried out for random ligands and for those ligands which were known to be active for the given protein. The probability that a random ligand will prove to be active is less than 10⁻⁴, therefore all random ligands will hereafter in the context of the invention be termed inactive. The quality of the virtual screening was evaluated in terms of the following parameters EF—enrichment factor—and q.

$$EF = ( \frac{{HITS}_{sampled}}{{N}_{sampled}} ) / ( \frac{{HITS}_{total}}{{N}_{total}} ) ,$$

where
Nₜₒₜₐₗ is the number of ligands participating in the virtual screening;
N_{sampled} is the number of ligands with the best score, selected into the group for the investigation;
HITSₜₒₜₐₗ is the number of active ligands participating in the virtual screening, i.e., of such ligands which are known to be active for the given protein;
HITSₛₐₘₚₗₑₛ is the number of active ligands which have found their way into the group for the investigation with the best score

$$q = \frac{{N}_{best}}{N}$$

where
N is the number of ligands participating in the virtual screening; N_{best} is the number of random inactive ligands in which the score after the virtual screening is better than the average score of the active ligands after the same virtual screening.

The greater is the number of active ligands which get into the group with the best score, the better the quality of the virtual screening is, the larger the parameter EF and the smaller the parameter q are. If in the course of virtual screening the score of the ligands is predicted in a random manner, then EF˜1, and q˜0.5.

Virtual screening was carried out for the binding site of trypsin protein (use was made of the protein structure with the code 1eb2, taken from the protein data bank (The RCSB Protein Data Bank (PDB), http:://www.pdb.org), thymidine kinase (structure with the code 1kim) and cyclin-dependent kinase 2 (structure with the code 1di8). The binding site in proteins was defined as a square with sides of 25×25×25 angstroms at the center coinciding with the center of the native ligand presented in the-initial-protein structures. 25 active ligands for trypsin were selected from the set of the ligands known to be active for trypsin, 10 active ligands for thymidine kinase and 46 for cyclin-dependent kinase 2 were selected from the set of ligands active for thymidine kinase and correspondingly for cyclin-dependent kinase 2, the structures of which in the binding site are represented in the PDB. Random ligands were selected from the set of commercially available chemical substances so that in terms of common properties such as the molecular weight, the number of hydrogen bond donor atoms, the number of hydrogen bond acceptor atoms, random ligands should resemble the active ligands. All ligands were protonated for pH=7.4.

In the course of virtual screening, docking for ligands was carried out with the aid of a docking program. The algorithm of searching for optimal position of a ligand in the docking program is analogous to the algorithm of the GLIDE program (Schrodinger, LLC, New York, N.Y., USA, http://www.schrfodinger.colm/ProductDescription.php?mID=6&sID=6&cID=0). First, inspection of the set of the initial positions of the ligand in the binding site was carried out, then the selection of the best positions, local minimization of these positions, applying the method of simulated annealing thereto and selecting the best out of the obtained positions are performed.

The program of docking was tested in a standard manner: the known 3D structures of the ligand in the protein binding site were taken, this ligand was removed, docking of the removed ligand into the binding site was carried out, and the initial (native) position of the ligand and the position obtained as a result of the docking were compared. Practically In all tests of the program a mismatch of the native position of the ligand with the position of the ligand obtained in the result of the docking was conditioned only by that the latter position had a better score than any position near the native one, i.e., the algorithm of searching for the best position of the ligand in the majority of cases operated correctly, and all failures in the docking were caused by the score being not quite correct.

The score in the experiments had the following general form:

$$S = {\sum }_{i , j} {S}_{A , B} ( {r}_{i , j} ) + {S}_{0}$$

where i and j are the numbers of the atoms in the protein and in the ligand,
A and B represent the types of the atoms of the protein and of the ligand,
r_{i,j} is the distance between them,
S₀ is a certain constant.

The score between the atoms of different types was approximated by the following function;

$$S ( r ) = \{ \begin{matrix}e + {k ( r - {r}_{1} )}^{4} , & r < {r}_{1} \\ \frac{2 e}{{( {r}_{2} - {r}_{1} )}^{3}} {( r - {r}_{2} )}^{2} ( r - 1.5 {r}_{1} + 0.5 {r}_{2} ) , & {r}_{1} < r < {r}_{2} \\ 0 , & r > {r}_{2}\end{matrix}$$

Such score is continuous and differentiable for any r>0. The parameters e, r₁, r₂, k for each pair of the types A and B were varied in the course of score modification. For the atoms of the proteins and ligands the following typification was employed:
carbons in SP₃ hybridization;
carbons in SP₂ hybridization;
halogens (F, Cl, Br, I);
atoms which may act as hydrogen donors and hydrogen acceptors in hydrogen bond simultaneously (oxygen in OH group);
hydrogen acceptors in hydrogen bond (for instance, oxygen in C═O or in CO₂ group);
hydrogen donors in hydrogen bond (for instance, nitrogen in NH₃ group);
metals in protein binding site.

The interaction of hydrogens in an explicit form was not considered.

The initial score was obtained by a standard method: by fitting the parameters e, r₁, r₂, for the set of the known complexes of proteins with ligands so that the scores of native ligands after the local minimization of these ligands in the active site should correlate in the best manner with the experimental binding affinities known for these complexes.

The scores were modified by the following two methods.

First method—with the use of information about the position of active ligands in the binding site of the protein for which the score is being elaborated, comprised the following steps (operations):
carrying out virtual screening of active and random (inactive) ligands in the binding site;
random selection of several inactive ligands into the training set and modification of the score in such a manner that the new score for any positions of the inactive ligands obtained as a result of docking in the preceding step should be worse than the new score in the known positions of the active ligands in the protein binding site;
controlling the quality of the new score with the help of virtual screening of the active and random (inactive) ligands into the binding site with this new score.

Second method—with the use of information about the position of active ligands in the binding site of proteins and with their experimental binding affinities, these proteins being other than the protein for which the score is being elaborated, comprised the following steps:
carrying out virtual screening of active and random (inactive) ligands in the binding site;
random selection of several inactive ligands into the training set and modification of the score in such a manner that the new score for any positions of the inactive ligands obtained as a result of docking in the preceding step should be worse than a definite value, and the correlation between the new score for the set of the known complexes of proteins with ligands after local minimization of these ligands from the native position in the binding site and the experimental binding affinities known for these complexes should be preserved in the best way;
controlling the quality of the new score with the help of virtual screening of the active and random (inactive) ligands into the binding site with this new score.

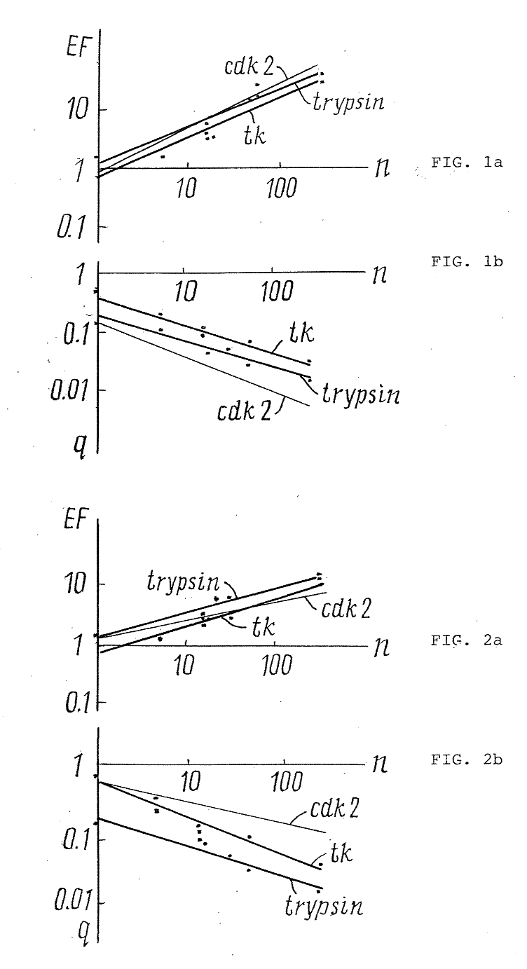

Presented in FIG. 1 are parameters which characterize the quality of virtual screening—q (FIG. 1a) and EF— enrichment factor—(the size of the group for the investigation was 2% of the number of the ligands participating in virtual screening) (FIG. 1b), for virtual screenings with scores modified according to method 1 depending on n—the number of random inactive ligands in the training set for trypsin proteins, thymidine kinase and cyclin-dependent kinase 2. As the active ligands for which the position in the binding site is known there were taken benzamidine for trypsin, native ligand from the structure with the code 1kim for tk thymidine kinase and native ligand from the structure with the code 1di8 for cyclin-dependent kinase 2 (the structures were taken from the database protein data bank (The RCSB Protein Data Bank (PDB), http:://www.pdb.org). In all screenings the parameters of docking, of the structure of molecules and of the binding site were not varied for one and the same protein, and only the scores were modified. From FIG. 1 it is seen that the quality of virtual screening is determined to a greater extent just by the score, and upon modification of the score the quality may be improved by orders of magnitude, the improvement being the better the larger the number of random inactive ligands in the training set is.

Presented in FIG. 2 are parameters which characterize the quality of virtual screening—q (FIG. 2a) and EF—enrichment factor—(the size of the group for the investigation was 2% of the number of the ligands participating in virtual screening) (FIG. 2b), for virtual screenings with scores modified according to method 2 depending on the number of random inactive ligands in the training set for trypsin, thymidine kinase and cyclin-dependent kinase 2 proteins. The set of the known complexes of proteins with ligands and experimental binding affinities, for which the correlation of the new modified score was controlled after the local minimization of these ligands from the native position in the binding site with the experimental binding affinities known for these complexes was obtained by the selection of the complexes described in the papers (Ishchenko A. V, Shakhnovich E. I., J. Med. Chem. 2002, 45, 2770-2780 and Wang R., Lu Y., Wang S., D. J. Med. Chem. 2003, 46, 2287-2303) among those complexes in which the ligands were sufficiently rigid and small. 86 sets entered into the final complex. In all virtual screenings the parameters of docking, of the structure of molecules and of the binding site were not varied for one and the same protein, and only the scores were modified.

From FIG. 2 it is seen that in the case of method 1 the quality of virtual screening is determined just by the score and upon modification of the score the quality may also be improved by orders of magnitude, the improvement being the better the larger the number of random inactive ligands in the training set is.

In method 2 use is made of information about active ligands for proteins other than the protein on which virtual screening is carried out, while in method 1 use is made of information about active ligands for the protein on which virtual screening is being carried out. Therefore, with the same number of random inactive ligands in the training set, the quality of the score obtained in method 1 is better than in method 2.

However, method 2 for its operation does not require information about the position of active ligands for a definite protein and information about the position of active ligands in the binding site for this protein, such information being not always available in practice. Hence, method 1 and method 2 mutually complement each other, and while method 1 is more effective under definite conditions, method 2 is more universal.

1. A method for selecting potential medicinal-compounds, which comprises predicting the value of the binding affinity or the free energy of the ligand-protein interaction from the score calculated with the help of a scoring function for a molecular complex comprising a ligand molecule and a protein molecule with taking into account the protein structure, the ligand structure and the ligand position in the protein binding site, constructing of the scoring function, characterized in that the scoring function for said molecular complex is constructed with the use of active and inactive ligands and in that the method contemplates the following steps:
a) selecting a set of experimental data about the position of active ligands in the binding site of protein for which a score will be elaborated;
b) selecting a set of experimental data about the positions of inactive ligands in the binding site of protein for which a score will be elaborated;
c) modifying the known initial score in such a manner that for each active ligand from the set obtained in step a) the value of a new score should be smaller than its value calculated for any position of inactive ligand from the set obtained in step b); and/or
d) selecting a set of experimental data about the position of active ligands in the binding site of arbitrary proteins;
e) modifying the known initial score in such a manner that for each active ligand from the set obtained in step d) the value of a new score should be smaller than its value calculated for any position of inactive ligand from the set obtained in step b);
f) carrying out virtual screening of ligands with the new score and, if necessary, evaluating its quality;
g) selecting ligands with the minimum score value and measuring the binding free energy and, if necessary, repeating steps a)-e) until a ligand with a binding free energy less than −9 kcal/mole is detected.

2. The method according to claim 1, in which the score has the following general form
$$S = {\sum }_{i , j} {S}_{A , B} ( {r}_{i , j} ) + {S}_{0}$$
where i and j are the numbers of the atoms in the protein and in the ligand,
A and B represent the types of the atoms of the protein and of the ligand,
r_{i,j} is the distance between them,
S₀ is a certain constant.

3. The method according to claim 2, in which the score between the atoms of different types is approximated by the following function
$$S ( r ) = \{ \begin{matrix}e + {k ( r - {r}_{1} )}^{4} , & r < {r}_{1} \\ \frac{2 e}{{( {r}_{2} - {r}_{1} )}^{3}} {( r - {r}_{2} )}^{2} ( r - 1.5 {r}_{1} + 0.5 {r}_{2} ) , & {r}_{1} < r < {r}_{2} \\ 0 , & r > {r}_{2}\end{matrix}$$
wherein the score is continuous and differentiable for any r>0;
the parameters e, r₁, r₂, k for each pair of the types A and B being varied in the course of score modification.

4. The method according to claim 4, in which the following typification is employed for the atoms of proteins and ligands
carbons in SP₃ hybridization;
carbons in SP₂ hybridization;
halogens (F, Cl, Br, I);
atoms which may act as hydrogen donors and hydrogen acceptors in hydrogen bond simultaneously (oxygen in OH group);
hydrogen acceptors in hydrogen bond (for instance, oxygen in C═O or in CO₂ group);
hydrogen donors in hydrogen bond (for instance, nitrogen in NH₃ group);
metals in protein binding site.
the interaction of hydrogens in an explicit form is not considered.

5. The method according to claim 1, in which the initial score is obtained by fitting the parameters e, r₁, r₂ for the set of the known complexes of proteins with ligands so that the scores of native ligands after the local minimization of these ligands in the active site should correlate in the best manner with the experimental binding affinities known for these complexes.

6. The method according to claim 1, in which the quality of the virtual screening is evaluated in terms of the following parameters enrichment factor—EF and q.
$$EF = ( \frac{{HITS}_{sampled}}{{N}_{sampled}} ) / ( \frac{{HITS}_{total}}{{N}_{total}} ) ,$$
where
Nₜₒₜₐₗ is the number of ligands participating in the virtual screening;
N_{sampled} is the number of ligands with the best score, selected into the group for the investigation;
HITSₜₒₜₐₗ is the number of active ligands participating in the virtual screening, i.e., of such ligands which are known to be active for the given protein;
HITSₛₐₘₚₗₑₛ is the number of active ligands which have found their way into the group for the investigation with the best score
$$q = \frac{{N}_{best}}{N}$$
where
N is the number of ligands participating in the virtual screening;
N_{best} is the number of random inactive ligands in which the score after the virtual screening is better than the average score of the active ligands after the same virtual screening.

7. The method according to claim 1, in which in the course of virtual screening, docking for ligands was carried out with the aid of a docking program and the algorithm of searching for optimal position of a ligand in the docking program is analogous to the algorithm of the GLIDE program which reduces to that, first, inspection of the set of the initial positions of the ligand in the binding site is carried out, then the selection of the best positions, local minimization of these positions, applying the method of simulated annealing thereto and selecting the best out of the obtained positions are performed.

8. The method according to claim 7, in which the program of docking is tested in the following manner: the known 3D structures of the ligand in the protein binding site are taken, this ligand is removed, docking of the removed ligand into the binding site is carried out, and the initial (native) position of the ligand and the position obtained as a result of the docking are compared; practically in all tests of the program a mismatch of the native position of the ligand with the position of the ligand obtained in the result of the docking is conditioned only by that the latter position had a better score than any position near the native one, i.e., the algorithm of searching for the best position of the ligand in the majority of cases operates correctly, and all failures in the docking are caused by the score being not quite correct.

9. The method according to claim 1, in which the scores are modified with the use of information about the position of active ligands in the binding site of the protein for which the score is being elaborated, and the modification comprises the following steps:
carrying out virtual screening of active and random (inactive) ligands in the binding site;
random selection of several inactive ligands into the training set and modification of the score in such a manner that the new score for any positions of the inactive ligands obtained as a result of docking in the preceding step should be worse than the new score in the known positions of the active ligands in the protein binding site;
controlling the quality of the new score with the help of virtual screening of the active and random (inactive) ligands into the binding site with this new score.

10. The method according to claim 1, in which the scores are modified with the use of information about the position of active ligands in the binding site of proteins and with their experimental binding affinities, these proteins being other than the protein for which the score is being elaborated, and the modification comprises the following steps:
carrying out virtual screening of active and random (inactive) ligands in the binding site;
random selection of several inactive ligands into the training set and modification of the score in such a manner that the new score for any positions of the inactive ligands obtained as a result of docking in the preceding step should be worse than a definite value, and the correlation between the new score for the set of the known complexes of proteins with ligands after local minimization of these ligands from the native position in the binding site and the experimental binding affinities known for these complexes should be preserved in the best way;
controlling the quality of the new score with the help of virtual screening of the active and random (inactive) ligands into the binding site with this new score.

11. The method according to claim 1, in which virtual screening is carried out for the binding site of trypsin protein, using the protein structure with the code 1 eb2, taken from the protein data bank,), thymidine kinase (structure with the code 1kim) and cyclin-dependent kinase 2 (structure with the code 1di8); the binding site in proteins is defined as a square with sides of 25×25×25 angstroms at the center coinciding with the center of the native ligand presented in the initial protein structures; 25 active ligands for trypsin are selected from the set of the ligands known to be active for trypsin, 10 active ligands for thymidine kinase and 46 for cyclin-dependent kinase 2 are selected from the set of ligands active for thymidine kinase and correspondingly for cyclin-dependent kinase 2, the structures of which in the binding site are represented in the PDB; random ligands are selected from the set of commercially available chemical substances so that in terms of common properties such as the molecular weight, the number of hydrogen bond donor atoms, the number of hydrogen bond acceptor atoms, random ligands should resemble the active ligands; all ligands are protonated for pH=7.4.

12. The method according to claim 11, in which the quality of virtual screening to a greater extent is determined by the score, and the score modification improves the quality of virtual screening with an increase of the number of random inactive ligands in the training set.
